(19) United States
(12) Patent Application Publication
(10) Pub. No.: US 2015/0355977 A1
(43) Pub. Date: Dec. 10, 2015

(54) System and Method for Making a Backup Copy of Live Data

(71) Applicants: Bradley C. Kuszmaul, Lexington, MA (US); Christian E. Rober, Sea Cliff, NY (US)

(72) Inventors: Bradley C. Kuszmaul, Lexington, MA (US); Christian E. Rober, Sea Cliff, NY (US)

(21) Appl. No.: 14/300,490

(22) Filed: Jun. 10, 2014

(51) Int. Cl. G06F 11/14; G06F 17/30

(52) U.S. Cl. CPC G06F 11/1451; G06F 11/1435; G06F 17/30238; G06F 2201/84; G06F 2201/80

(57) ABSTRACT

A system and method for backing up data on computer-readable physical medium, especially useful for databases, such as those using POSIX standard function calls, whereby select operations performed by a user of the database are intercepted and, while performed, are also translated into a shadow file having information about a database file to be backed up and the operations performed on that file. The resulting shadow file can be used to reconstitute the database file. In another mode of operation, the system and method create a copy of the database and concurrently make the same changes to the copy as the user commands while also concurrently keeping a shadow file system related to the database copy.

### RELATED APPLICATIONS

This application claims priority to U.S. Provisional Application No. 61/833,297, filed 10 Jun. 2013, the disclosure of which is incorporated herein by reference.

### BACKGROUND OF THE INVENTION

1. Field of the Invention

This invention relates to making a copy of live data stored on a computer-readable medium.

2. The Art

This invention relates to the storage of information on computer-readable media, and especially to a system, device, and method for making a copy of such data. Computer-readable information is stored on media such as optically-readable articles (such as DVDs and CDs) and magnetic tape, as well as media associated with such known devices such as disk drives, solid state disk drives, as well as various other data storage articles, devices, and systems.

While a computer system will access such information on such computer-readable media during its operation, a second copy, or further copies, of the information may be needed or desirable to have. The second copy (and further copies) can be used in several ways. For example, a copy of the information might be transferred to a remote location as a backup or archive in order to account for the possibility of a flood, fire, or other occurrence at a primary location where the information is stored from rendering any part of the information unreadable, unretrievable, or otherwise unusable. Another example would be making a copy of the information available to a second computer system, or multiple computer systems, in order to provide increased data query performance: the data (information) could then be read by each computer having its own copy of the data at any one time. Yet another example is making a copy of the data and transferring that copy to another geographical location so that queries made at that other location can be performed locally, without sending both information and query instructions over a network. There are many other uses of and reasons to have a copy of data.

### SUMMARY OF THE INVENTION

In one embodiment, this invention provides a system for backing up data in a POSIX application environment, the data stored on a computer-readable physical medium, comprising:

a library that intercepts predetermined POSIX file operations and performs such operations on a copy of the data defined by a shadow system;

the shadow system comprising,
a shadow file descriptor map comprising one or more pointer related to one or more data files to be backed up, each pointer unique to a given process working on the data, and each pointer being null or pointing to a shadow file description;
a shadow file description, each comprising an offset, a shadow file reference count, and a pointer to a shadow file;
a shadow name map comprising, for each open data file to be backed up, a mapping of the name of that open file to a corresponding shadow file;
a shadow file reference comprising, for each file name in the shadow name map an associated device and file number;
a shadow file reference map comprising, for each the shadow file reference a map to a corresponding shadow file; and
a shadow file, comprising, for each open data file to be backed up, information from the shadow file description, the shadow name map, and the shadow file reference map,
   whereby each shadow file includes information from which each open data file can be reconstituted.

In another embodiment, this invention provides a system for backing up data in a POSIX application environment, the data stored on a computer-readable physical medium, comprising:

a source space comprising data to be backed up;

a destination space comprising a copy of the data to be backed up;

a library that intercepts predetermined POSIX file operations and performs such operations on the copy of the data in the destination space;

a shadow system comprising,
a shadow file descriptor map comprising one or more pointer related to one or more data files in the destination space, each pointer unique to a given process working on the data in the destination space, and each pointer being null or pointing to a shadow file description;
a shadow file description, each comprising an offset, a shadow file reference count, and a pointer to a shadow file;
a shadow name map comprising, for each open data file in the destination space, a mapping of the name of that open file to a corresponding shadow file;
a shadow file reference comprising, for each file name in the shadow name map an associated device and file number;
a shadow file reference map comprising, for each the shadow file reference a map to a corresponding shadow file; and
a shadow file, comprising, for each open data file in the destination space, information from the shadow file description, the shadow name map, and the shadow file reference map,
   whereby each shadow file includes information from which each open data file in the destination space can be reconstituted.

### BRIEF DESCRIPTION OF THE DRAWINGS

FIG. 1 depicts an example of the shadow state during the so-called normal mode of operation of the invention, as defined and described hereinafter.

FIG. 2 depicts an example of the shadow state during the so-called backup mode of operation of the invention, as defined and described hereinafter.

### DETAILED DESCRIPTION

To understand how our invention works requires understanding how standard data storage systems are organized. A database application operates by performing operations on a file system. In order to perform operations on the database, such as creating new data entries, changing existing data, retrieving data (such as for viewing on a screen or a printout), the programmers of the database use software that includes “function calls.” These function call are specified by the POSIX standard. (See INSTITUTE OF ELECTRICAL AND ELECTRONIC ENGINEERS. Information technology—Portable Operating System Interface (POSIX)—Part 1: System application program interface (API) [C language]. IEEE Standard 1003.1. 1996 Edition. The disclosure of which is incorporated herein by reference.)

The abstraction provided by the POSIX standard can be understood with reference to the following definitions, which are capitalized for ease of reference throughout this specification:

A “file” (FILE) comprises an array of bytes, typically stored on disk, but can be stored on any computer-readable medium. The system {(1) Inventive DB system? OS? Some system below the DB system?}) maintains the file length and some additional attributes such as the owner of the file and permissions information which specifies which users may read or write the file. That is, among other characteristics of a particular file, the system keeps track of the size of the file and who (which user(s) of the system) can access and alter the file data. The system provides a unique identifier for each file, the “file reference,” defined below. As is typical, each file will also have a file name uniquely identifying that file.

The FILE also includes an integer, called the “FILE REFCOUNT,” that counts the number of file descriptions (defined below) plus the number of name-map entries that refer to that particular file.

A “file description” (FILE DESCRIPTION) comprises an offset and a file reference (as noted, defined below). The offset is a nonnegative integer that identifies where in the FILE the next byte read will be read from, or to where the next byte will be written. Different FILE DESCRIPTIONS can refer to the same FILE, for example, if the FILE has been opened twice. The system maintains at least one FILE DESCRIPTION for each open FILE.

The FILE DESCRIPTION also includes an integer, called the “description refcount” (DESCRIPTION REFCOUNT) that counts the number of open file descriptors (defined below) that refer to a given file description.

A “file descriptor” (FILE DESCRIPTOR) is an integer that, within the context of a process, identifies a FILE DESCRIPTION. Different FILE DESCRIPTORS can refer to the same FILE DESCRIPTION or to different FILE DESCRIPTIONS. While the present invention is applicable to multiple processes being performed concurrently on stored information (for example, being performed on different data in a given database), for ease of discussion the invention is described with reference to the situation where a single process is running. Nevertheless, for example, when dealing with multiple processes, the same FILE DESCRIPTOR may refer to different FILE DESCRIPTIONS. Thus, a FILE DESCRIPTOR implicitly includes the process identifier. Hence, the FILE DESCRIPTOR is context-sensitive with regard to the processes being run concurrently, and so it is possible for FILE DESCRIPTORS in different processes to refer to the same FILE DESCRIPTION, and the same FILE DESCRIPTOR in different processes run on a given database to refer to different FILE DESCRIPTIONS in the same database.

A “descriptor map” (DESCRIPTOR MAP) comprises a mapping of FILE DESCRIPTORS to FILE DESCRIPTIONS. The present invention maintains a DESCRIPTOR MAP for each process.

A “name map” (NAME MAP) comprises a map from FILE NAMES to file references (defined below).

A “file reference” (FILE REFERENCE) uniquely identifies a FILE. For example, in certain UNIX systems, a FILE REFERENCE will comprise a device number, which might specify a particular disk drive on which a FILE is stored, and a file number, sometimes referred to as the inode number.

The operation of the foregoing POSIX function calls will now be described with respect to a single process. Error cases, such as opening a FILE that does not exist, writing to a disk that has run out of space, or reading beyond the end of a FILE, are ignored in the following description, and it is well within the abilities of one of ordinary skill in the art to implement error handling operations to account for such occurrences.

In a process according to this invention, all functions are called. {??}

1) int open(char *pathname, int flags, int mode);

This command opens the FILE named by pathname and returns an integer by which the then-opened FILE can be referred. This integer is the FILE DESCRIPTOR. The flags argument indicates whether the FILE is to be opened in read-only mode or write-only mode, whether the file should be created if it does not already exist, and so forth. The mode indicates the permissions in the case that a new FILE needs to be created. There is a separate function, called creat, dedicated to creating a FILE. The creat operation can be effected by an open operation.

For example, to create a FILE, the system performs the following operations:

a) Create a new FILE of length zero.

b) Create an entry in the NAME MAP that maps the provided FILE name to a FILE REFERENCE for the new FILE. This new FILE has FILE REFCOUNT equal to two (one for the NAME MAP and one for the FILE DESCRIPTION).

c) Create a new FILE DESCRIPTION referring to the newly created FILE. This new FILE DESCRIPTION has offset zero and FILE REFCOUNT equal to one.

d) Find a FILE DESCRIPTOR, fd, that is currently unused by the process.

e) Update the DESCRIPTOR MAP so that fd maps to the FILE DESCRIPTION.

f) Return fd, which now refers to an open FILE.

As another example, to open an existing FILE, the system performs the following operations:

a) Find the FILE REFERENCE from the NAME MAP.

b) Increment the FILE REFCOUNT on the file. {Should this be step d)?}

c) Create a new FILE DESCRIPTION with offset zero and FILE REFCOUNT equal to one.

d) Find a FILE DESCRIPTOR, fd, that is currently unused by the process.

e) Update the DESCRIPTOR MAP so that fd maps to the FILE DESCRIPTION.

f) Return fd, which now refers to an open file. Return the new file descriptor.

2) int close(int fd);

Closes the file referred to by the FILE DESCRIPTOR fd. The FILE DESCRIPTOR can no longer be used, for example in a read or write operation. Thus, to close a FILE, the system performs the following operations:

a) Find the FILE DESCRIPTOR in the fd^{th} entry of the descriptor map.

b) Decrement the DESCRIPTOR REFCOUNT of the descriptor.

c) If the DESCRIPTOR REFCOUNT becomes zero, then decrement the FILE REFCOUNT on the file and free the description.

d) If the FILE REFCOUNT on the FILE becomes zero, then free the resources used by the FILE.

e) Clear the fd^{th} entry in the DESCRIPTOR MAP.

f) Return the integer 0 if there are no errors.

3) int write(int fd, void*buf, int size);

Write size bytes of data from buf to the FILE at the offset specified by the offset in the corresponding FILE DESCRIPTION. Increments, by size the offset of the FILE DESCRIPTION. Return the number of bytes read.

4) int read(int fd, void*buf, int size);

Read size bytes of data into buf from the FILE at the offset specified in the corresponding FILE DESCRIPTION. Increments, by size, the offset of the FILE DESCRIPTION. Return the number of bytes written.

5) int lseek(int fd, int offset, int whence);

Consider the file description corresponding to FILE DESCRIPTOR fd. If whence equals zero, then set the offset of the FILE DESCRIPTION to offset. If whence equals one, then increment the offset of the FILE DESCRIPTION by offset. If whence equals two, then set the offset of the FILE DESCRIPTION to the sum of offset and the size of the FILE. Return the new offset.

6) int pwrite(int fd, void*buf, int nbyte, int offset);

Write nbyte bytes of data from buf to the FILE at the offset specified by the offset argument. This function does not change the offset of the corresponding FILE DESCRIPTION. Return the number of bytes written.

7) int ftruncate(int fd, int length);

Consider the FILE DESCRIPTION corresponding to fd and the file referenced by that FILE DESCRIPTION. Set the length of the FILE to length, discarding any data beyond what is now the end of the file. Return 0 on success.

8) int truncate(char *pathname, int length);

Use pathname to find a FILE in the NAME MAP. Set the length of the FILE to length. Return 0 on success.

9) int unlink(char *pathname);

Remove the NAME MAP entry mapping pathname to a FILE. Decrement the DESCRIPTOR REFCOUNT on the FILE, and if it becomes zero, free the resources used by the FILE. Return 0 on success.

10) int rename(char *oldpath, char *newpath);

Consider the FILE, F, mapped by the NAME MAP via oldpath. If there is a FILE mapped to by newpath, unlink it, as described above via the unlink function call. Remove the NAME MAP entry mapping for oldpath, and create one mapping newpath to F. Return 0 on success.

11) int dup(int oldfd);

Find a new fd that is unused. Create a DESCRIPTOR MAP entry mapping from fd to the FILE DESCRIPTION corresponding to oldfd. Return the new fd.

12) int mkdir(char *pathname, mode_t mode);

In POSIX, there is a directory hierarchy with directories and subdirectories and so forth. This function creates a new directory in the POSIX directory hierarchy.

13) int link(char *oldpath, char *newpath);

This function call creates a hard link from newpath to the FILE referenced by oldpath. This is implemented by updating the NAME MAP to point to the FILE, and updating the corresponding FILE REFCOUNT.

The system of this invention interposes a library that intercepts the POSIX file operations to allow backups to be performed. For each of the above POSIX file operations, the system defines two functions, one which the application calls (the “application call”), and one which the present invention uses to do the real work of the backup operation (the “real call”). Thus, in operation, for example, there are two functions for close: the application call close which is called by, for example, the database application when it wants to close a FILE and the real call which is implemented by the present invention. For convenience, we refer to them, respectively, as follows:

application call: int close(char *pathname, int flags, int mode);
real call: int real_close(char *pathname, int flags, int mode);
The present invention provides a library that defines ap_open and real_open {??“that defines the application call and real calls”; can the SM/W or H/W just be inserted modularly, or does some S/W or H/W of the existing system have to be modified?} by using program linker mechanisms. For example, in Linux, one can write the following code which uses a programming interface to the dynamic linking loader:

```
static int (*real_close) (int) NULL;
int close (int fd) {
      if (real_close==NULL) {
      real_close = dlsym(RTLD_NEXT, “close”);
      }
      perform_some_actions( );
      int r = real_close(fd);
      perform_more_actions( );
      return r;
}
```

In this code, the dlsym( ) call obtains a pointer to the real_close function. The application's close function is simply written as close. The close function (ap_close from the point of view of this invention) can perform various operations in the midst of which it actually closes the file with real_close. The present backup system thus “shadows” each of the POSIX function calls. The backup system's shadow functions implement backup, and in addition to calling the real functions, the backup system of this invention maintains shadows of the DESCRIPTOR MAP, NAME MAP, FILE DESCRIPTIONS, and the like, and information about each file. More particularly, the present system maintains, for each process, and analogous to the file-related definitions previously described:

a SHADOW FILE DESCRIPTOR MAP, which is an array indexed by FILE DESCRIPTOR, where each pointer is either NULL or it points to a SHADOW DESCRIPTION;

a SHADOW FILE DESCRIPTION, which has a structure including an offset and a pointer to a SHADOW FILE, as well as a corresponding FILE REFCOUNT argument;

a SHADOW FILE, a set of arguments which keeps track of which FILE is currently being written, the corresponding FILE REFERENCE, and the set of names that the FILE has been opened as;

a SHADOW NAME MAP, which maps filenames of open FILES to SHADOW FILES;

a SHADOW FILE REFERENCE comprising a device number and FILE number; and

a SHADOW FILE REFERENCE MAP, which maps SHADOW FILE REFERENCES to SHADOW FILES.

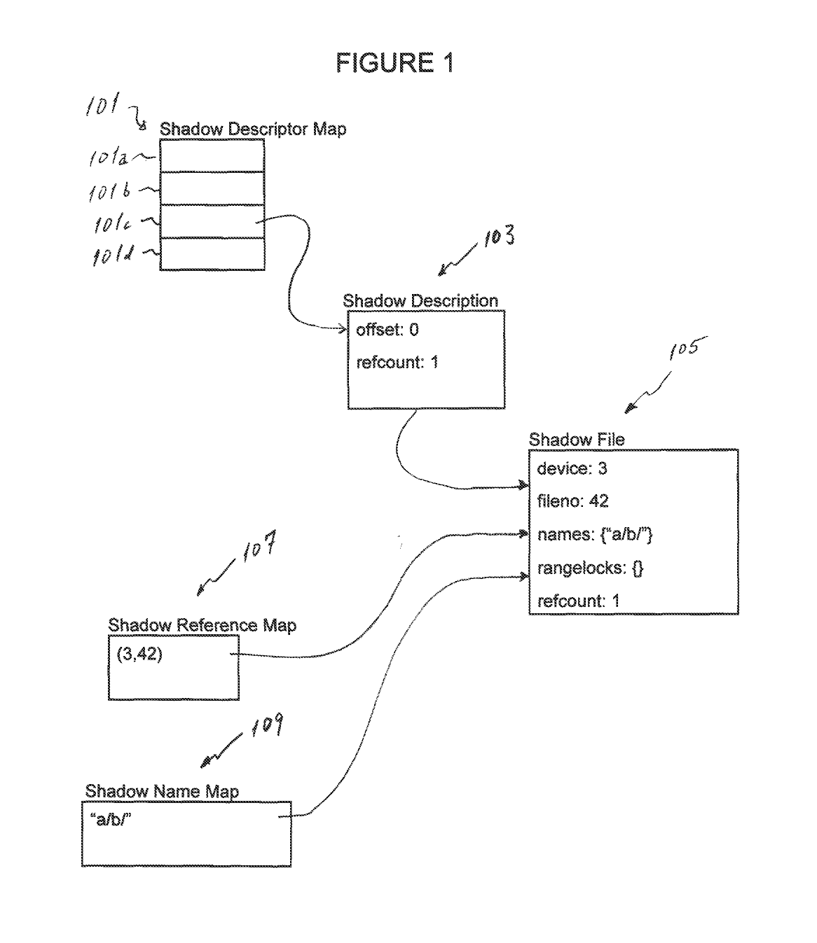

FIG. 1 depicts an exemplary shadow state existing during operation of the present invention. The figure shows the SHADOW DESCRIPTOR MAP (101) with the descriptor number two (101c) (the third descriptor, since descriptors are numbered as integers starting from zero) pointing to a SHADOW DESCRIPTION (103) having an offset equal to zero and a SHADOW FILE REFCOUNT equal to one (meaning there is one item in the SHADOW DESCRIPTOR MAP that points to it). The SHADOW DESCRIPTION in turn points to a SHADOW FILE (107) which, as determined by the arguments shown in the figure, resides on device 3, is file number 42, and has one FILE name (“/a/b”). A FILE can have no names if it is unlinked, and in systems that support hard file links, the FILE can have multiple names. The SHADOW FILE REFERENCE MAP shows an entry (107) that maps the pair shown in the figure as “(3,42),” corresponding to the device number and FILE number, to the SHADOW FILE. The SHADOW NAME MAP show and entry (109) that maps the FILE name “a/b” to the SHADOW FILE. The SHADOW FILE also contains a DESTINATION FILE DESCRIPTOR (called destfd), which is explained below.

The backup system of this invention has two modes of operation, termed herein a normal mode and a backup mode. In the normal mode, the present system maintains the shadow state. In the backup mode, the present system copies selected files for use as a backup copy of each such file while simultaneously causing every application call to modify the backup copy.

More particularly, in normal mode the backup system performs operations as follows:

open: After opening (or creating) the FILE with the real_open call, the system determines the file's device and file number (that is, it's SHADOW FILE REFERENCE). If there is no SHADOW FILE in the SHADOW FILE REFERENCE MAP, then a SHADOW FILE is created, and the map is updated. A SHADOW DESCRIPTION is created with offset zero pointing to the SHADOW FILE (either the old one if it existed, or the new one if created), the SHADOW DESCRIPTOR MAP is updated, and the SHADOW NAME MAP is updated to keep track of that FILE. Reference counts are updated analogously to what the real_open call does.

close: The SHADOW DESCRIPTOR MAP is used to find the SHADOW DESCRIPTION. The reference count is updated, and if the SHADOW DESCRIPTION is no longer needed (that is, no open descriptors refer to it), then the description is destroyed, and if the SHADOW FILE is no longer needed (that is, not referred to by any SHADOW DESCRIPTION), then the shadow file is likewise destroyed and removed from the SHADOW REFERENCE MAP and all the entries in the SHADOW NAME MAP that refer to the SHADOW FILE are removed. (The names set in the SHADOW FILE provides the set of relevant names to remove from the SHADOW NAME MAP.)

write: The write is performed and the corresponding SHADOW DESCRIPTION offset is updated.

read: The read is performed and the corresponding SHADOW DESCRIPTION offset is updated.

lseek: The seek is performed and the corresponding SHADOW DESCRIPTION offset is updated.

pwrite: The pwrite is performed, and no shadow state changes.

ftruncate: The ftruncate is performed with no shadow state changes.

truncate: The truncate is performed with no shadow state changes.

unlink: The unlink is performed, and the corresponding entry is removed from each of the SHADOW NAME MAP and from the SHADOW FILE.

rename: The unlink of the new name is performed, if necessary, and the SHADOW NAME MAP is updated, if there is an entry for that name, so that the map has the new name mapping to whatever the old name mapped to. The corresponding name in the SHADOW FILE is updated with the new name.

dup: The real dup is called, and the SHADOW DESCRIPTOR MAP is updated so that the SHADOW DESCRIPTION is referenced both by the old and the new descriptor. The corresponding SHADOW DESCRIPTION REFCOUNT is incremented.

mkdir: The real mkdir is called, and no change is needed in the shadow state.

link: The real link is called, and the corresponding operation is performed in the SHADOW NAME MAP so that the new name will refer to the SHADOW FILE referenced by the old name. The system adds the new name to the set of names in the SHADOW FILE.

In the other mode of operation, the aforementioned backup mode, the system copies the data to a backup file system. The present invention provides a way for a user to specify what files need to be backed up and to where they should be backed up. For example, the present system allows a user to specify a set of source directory hierarchies (hereinafter the “source space”), and for each source a corresponding destination hierarchy (collectively the “destination space”).

During backup mode, for every open FILE in the source space, the present system maintains an open FILE DESCRIPTOR in the destination space. Thus, when the system starts backup mode, for every open FILE in the source space the system creates a copy of that file in the destination space, opens it (using the real_open function), and stores a SHADOW FILE DESCRIPTOR in the destfd argument field of the SHADOW FILE, as further explained below.

In backup mode, the system also maintains another map, the CORRESPONDENCE MAP, which maps from FILE REFERENCES in the source space to corresponding SHADOW FILE REFERENCES in the destination space. Every FILE that is backed up in the backup mode is maintained in the CORRESPONDENCE MAP.

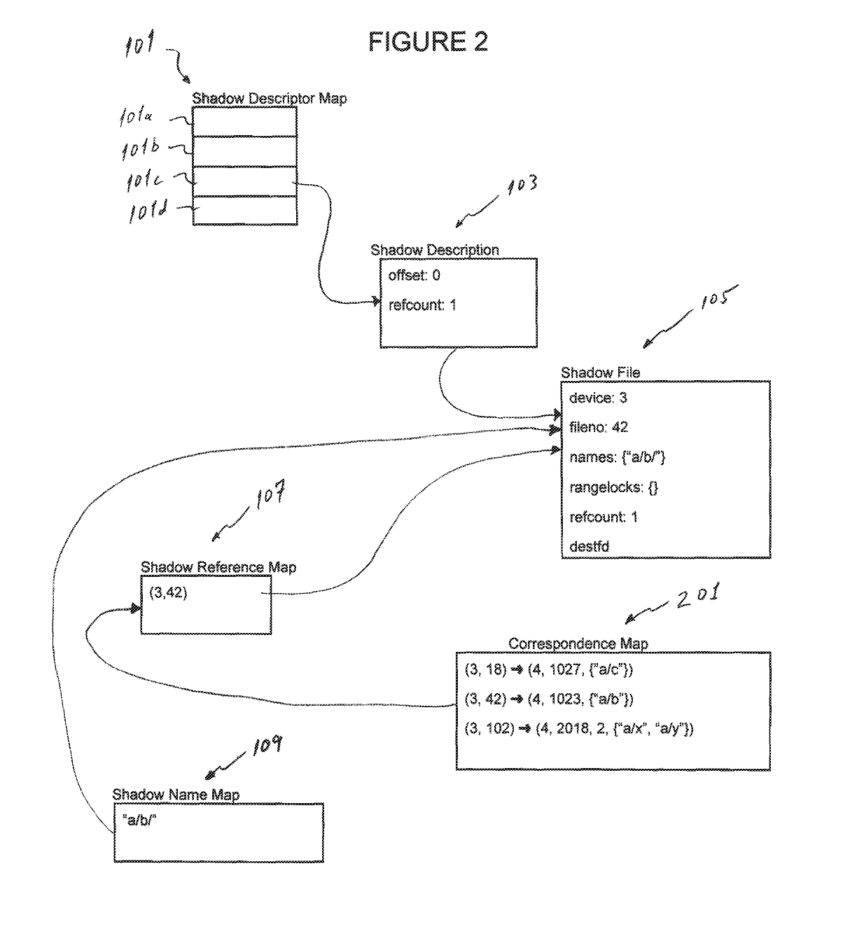

FIG. 2 depicts an example of the backup mode with the CORRESPONDENCE MAP 201. For example, with reference to FIG. 2, if the FILE on device 3, file number 42, is backed up to device 4, file number 1023, then the CORRESPONDENCE MAP would have an entry that looks like the second entry shown in the figure. More particularly, the CORRESPONDENCE MAP shown in FIG. 2 depicts three mappings, one mapping FILE REFERENCE “(3, 18)” to SHADOW FILE REFERENCE “(4, 1027)” with a notation that the name is “a/c”; one mapping “(3, 42)” to “(4, 1023)” with a notation that the name is “a/b”; and one mapping “(3, 102)” to “(4,2018)” with a notation that the file has two names, “a/x” and “a/y”.

The NAME MAP and REFERENCE MAP keep track of files that are open. The CORRESPONDENCE MAP keeps track of all the files that have been backed up. The CORRESPONDENCE MAP is preferably an on-disk data structure because this mapping can be very large compared to main memory. The CORRESPONDENCE MAP may, for example, use a B-tree or a Fractal Tree index.

During backup mode the system performs a recursive walk over the source space, copying every FILE in the source space to a corresponding location in the destination space, updating the CORRESPONDENCE MAP as it does so. During backup mode the system operates as follows:

open: When a FILE in the source space is opened, a corresponding SHADOW FILE is needed in the destination space. If the destination space file does not exist, then a destination SHADOW FILE is created. Thereafter (and if the SHADOW FILE already exists, then) it is opened with real_open, and the resulting SHADOW FILE DESCRIPTOR is stored in the destfd argument of the SHADOW FILE. The correspondence map is also updated.

close: When a file is closed, the destfd is closed if the SHADOW FILE is destroyed.

write: When data is written into a FILE that is in the source space, the same data is written into the SHADOW FILE using the destfd argument. The data is written to the same location. The system maintains an exclusive lock on the range being written so that if two writes occur at the same time, the backup file will always get the same data, written in the same order, as the source file

read: No additional action is needed beyond normal mode.

lseek: No additional action is needed beyond normal mode.

pwrite: Similar to write. Data is also written to the destination hierarchy if the file being written is in the source space.

ftruncate: If the file is in the source space, then the corresponding file is truncated in the destination space.

truncate: If the file is in the source space, then the corresponding file is truncated in the destination space.

unlink: If the file is in the source space, then the corresponding file is unlinked in the destination space. The NAME MAP and SHADOW FILE NAME set are updated as for normal operation. The CORRESPONDENCE MAP is also updated. If the name is in the CORRESPONDENCE MAP, it's removed. If the resulting name set is empty, then the entry in the CORRESPONDENCE MAP can be removed. If it turns out that there's another name for the file (for example, created by hard link) that the backup system has not yet copied, the file will be copied again, making the result correct.

rename: We can think of rename as performing the following set of operations: unlink the new name (if it exists); link the new name to the file; and unlink the old name. Care must be taken to make the rename operation atomic with respect to other threads.

dup: No additional action is needed beyond normal mode.

mkdir: In addition to normal mode, if the directory is in the source space, then a corresponding directory is created in the destination space.

link: If the FILE has already been backed up (or is being backed up) then it contains an entry in the CORRESPONDENCE MAP. If the FILE is referenced by an entry in the CORRESPONDENCE MAP, and if the new path is in the source space, then we create a corresponding link in the destination space and update the CORRESPONDENCE MAP. If the FILE is not contained in an entry in the CORRESPONDENCE MAP, and the new path is in the source space, then we arrange to copy the file from the source to the destination and create an entry in the CORRESPONDENCE MAP. The copying does not necessarily need to be finished before the link returns.

The above named POSIX file operations can incur error conditions. It will be apparent to one of ordinary skill in the art that how check for error conditions. For example, when closing a FILE DESCRIPTOR that is not currently open, an error would be returned. This can be checked by verifying that the DESCRIPTOR MAP contains a valid entry before trying to close the file. Similarly, when unlinking a file that is not present, an error occurs. This error condition can be checked by looking in the SHADOW NAME MAP to see if the file exists.

Concurrent access to the various mapping data structures must be synchronized between various threads that are running. It will be apparent to one of ordinary skill in the art how to use locks or other synchronization protocols to provide correct behavior even in the face of concurrent activity. It is preferable to use range locks, because, although they do not protect the data structures themselves, they do protect the integrity of the backed up data.

The foregoing description has used reference counting to decide when data structures can be destroyed. It will be apparent to one of ordinary skill in the art that there are other ways to reclaim memory. For example, a system could use garbage collection.

Some UNIX systems provide a file operation mode called direct I/O. Direct I/O can sometimes offer a performance advantage. Direct I/O can be accommodated by opening the destination file with direct I/O whenever the application opens a source file with direct I/O. When copying a file, all the activity can be performed with direct I/O, except for the last few bytes of the file, if the file length is not a multiple of 512 bytes. In Linux systems, files opened in direct I/O mode require that all operations occur on 512-byte boundaries, and thus operate on data blocks that are a multiple of 512 bytes in size. Accordingly, the last bytes of a file with a length that is not a multiple of the block size must be performed with non-direct I/O.

Variations on the foregoing descriptions will be apparent to one of ordinary skill in the art, and such variations that are within the scope and spirit of the invention are intended to be covered by the claims. For example, in backup mode, instead of copying files directly to a backup/destination directory hierarchy, the destination files can be serialized into a stream of bytes and then sent over a pipeline or IP socket to another process, optionally running on another machine, where they are reconstituted in a destination space. It will be apparent to one of ordinary skill in the art how to send the information over such a pipeline or socket, or using other communications mechanisms, such as a remote procedure call.

As a result of copying the source space to a destination space, the system creates a snapshot in time of the source space. This snapshot takes effect at the moment that the backup is finished: it is as though the entire source space were instantaneously copied to the backup space at that moment.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A system for backing up data in a POSIX application environment, said data stored on a computer-readable physical medium, comprising:
a library that intercepts predetermined POSIX file operations and performs such operations on a copy of the data defined by a shadow system;
said shadow system comprising,
a shadow file descriptor map comprising one or more pointer related to one or more data files to be backed up, each pointer unique to a given process working on said data, and each pointer being null or pointing to a shadow file description;
a shadow file description, each comprising an offset, a shadow file reference count, and a pointer to a shadow file;
a shadow name map comprising, for each open data file to be backed up, a mapping of the name of that open file to a corresponding shadow file;
a shadow file reference comprising, for each file name in the shadow name map an associated device and file number;
a shadow file reference map comprising, for each said shadow file reference a map to a corresponding shadow file; and
a shadow file, comprising, for each open data file to be backed up, information from said shadow file description, said shadow name map, and said shadow file reference map;
whereby each shadow file includes information from which each open data file can be reconstituted.

2. A system for backing up data in a POSIX application environment, said data stored on a computer-readable physical medium, comprising:
a source space comprising data to be backed up;
a destination space comprising a copy of said data to be backed up;
a library that intercepts predetermined POSIX file operations and performs such operations on the copy of the data in said destination space;
a shadow system comprising,
a shadow file descriptor map comprising one or more pointer related to one or more data files in said destination space, each pointer unique to a given process working on said data in said destination space, and each pointer being null or pointing to a shadow file description;
a shadow file description, each comprising an offset, a shadow file reference count, and a pointer to a shadow file;
a shadow name map comprising, for each open data file in the destination space, a mapping of the name of that open file to a corresponding shadow file;
a correspondence map comprising, for each data file in the source space to be backed up, a mapping to a corresponding data file in the destination space;
a shadow file reference comprising, for each file name in the shadow name map an associated device and file number;
a shadow file reference map comprising, for each corresponding data file in the correspondence map, a mapping to a corresponding shadow file; and
a shadow file, comprising, for each open data file in the destination space, information from said shadow file description, said shadow name map, and said shadow file reference map, and a file descriptor for each open data file in the source space;
whereby each shadow file includes information from which each open data file in the destination space can be reconstituted.

3. The system of claim 1, wherein said library modifies at least one POSIX call selected from the group consisting of open, close, write, read, lseek, truncate, unlink, rename, dup, mkdir, and link to modify said shadow system.

4. The system of claim 2, wherein said library modifies at least one POSIX call selected from the group consisting of open, close, write, pwrite, ftruncate, truncate, unlink, rename, dup, mkdir, and link to operate on both said copy of the data in the destination space and to modify said shadow system.

5. The system of claim 2, wherein said destination space is created by serializing the data files in the source space, sending the serialized files to a remote location, and reconstituting the files in said remote location to form the destination space.

6. A system for backing up data in a POSIX application environment, said data stored on a computer-readable physical medium, comprising:
intercepting predetermined POSIX file operations and concurrently performing operations on a copy of the data defined by a shadow system;
said shadow system comprising,
a shadow file descriptor map comprising one or more pointer related to one or more data files to be backed up, each pointer unique to a given process working on said data, and each pointer being null or pointing to a shadow file description;
a shadow file description, each comprising an offset, a shadow file reference count, and a pointer to a shadow file;
a shadow name map comprising, for each open data file to be backed up, a mapping of the name of that open file to a corresponding shadow file;
a shadow file reference comprising, for each file name in the shadow name map an associated device and file number;
a shadow file reference map comprising, for each said shadow file reference a map to a corresponding shadow file; and
a shadow file, comprising, for each open data file to be backed up, information from said shadow file description, said shadow name map, and said shadow file reference map;
whereby each shadow file includes information from which each open data file can be reconstituted.

7. A method for backing up data on in a POSIX application environment, said data stored on a computer-readable physical medium, comprising:
defining a source space comprising data on a computer-readable physical medium to be backed up;
defining a destination space comprising a copy of said data to be backed up on a second computer-readable physical medium;
intercepting predetermined POSIX file operations and performing such operations on the copy of the data in said destination space while concurrently maintaining a shadow system of data,
said a shadow system comprising,
a shadow file descriptor map comprising one or more pointer related to one or more data files in said destination space, each pointer unique to a given process working on said data in said destination space, and each pointer being null or pointing to a shadow file description;
a shadow file description, each comprising an offset, a shadow file reference count, and a pointer to a shadow file;
a shadow name map comprising, for each open data file in the destination space, a mapping of the name of that open file to a corresponding shadow file;
a correspondence map comprising, for each data file in the source space to be backed up, a mapping to a corresponding data file in the destination space;
a shadow file reference comprising, for each file name in the shadow name map an associated device and file number;
a shadow file reference map comprising, for each corresponding data file in the correspondence map, a mapping to a corresponding shadow file; and
a shadow file, comprising, for each open data file in the destination space, information from said shadow file description, said shadow name map, and said shadow file reference map, and a file descriptor for each open data file in the source space;
whereby each shadow file includes information from which each open data file in the destination space can be reconstituted.

8. The method of claim 6, wherein said library modifies at least one POSIX call selected from the group consisting of open, close, write, read, lseek, truncate, unlink, rename, dup, mkdir, and link to modify said shadow system.

9. The method of claim 7, wherein said library modifies at least one POSIX call selected from the group consisting of open, close, write, pwrite, ftruncate, truncate, unlink, rename, dup, mkdir, and link to operate on both said copy of the data in the destination space and to modify said shadow system.
